(19) United States
(12) Patent Application Publication
(10) Pub. No.: US 2006/0185739 A1
(43) Pub. Date: Aug. 24, 2006

(54) Valve connector

(76) Inventors: Nobuaki Niki, Inuyama-shi (JP); Yoshimitsu Ishida, Kasugai-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/359,293

(22) Filed: Feb. 22, 2006

(30) Foreign Application Priority Data
Feb. 24, 2005 (JP) 2005-048253

(51) Int. Cl. F16K 15/02

(52) U.S. Cl. 137/543.23

(57) ABSTRACT

The connector housing is integrally provided with a tube connecting portion on one axial end thereof and a pipe inserting portion on the other axial end thereof. An internal valve is disposed in the connector housing for opening and closing the through-path. The internal valve has a valve seat surface defined on an inner peripheral surface of the tube connecting portion. A valve body includes a closing portion with an abutting surface for abutting with the valve seat surface on an outer peripheral portion of the closing portion, and a compression spring biases the valve body in an axial direction. The valve body is configured to be movable in the axial direction within confines of the tube connecting portion that is provided with an annular stop rib.

### BACKGROUND OF THE INVENTION

1. Field of the Invention

The present invention relates to a valve connector to be used, for example, for controlling a fuel evaporating gas (vapor) in piping such as evaporation piping or vapor return piping in a fuel supply system of a motor vehicle.

2. Description of the Related Art

In order to prevent fuel vapor gas generated in a fuel tank of a motor vehicle from being discharged into an atmosphere, a vapor discharge prevention mechanism that causes the vapor to be adsorbed in a canister has been widely employed. In this type of vapor discharge prevention mechanism, evaporation piping connecting a fuel tank and the canister uses a one-way valve or a check valve to maintain an appropriate pressure in the fuel tank by controlling a flow of the vapor. And, in the vapor discharge prevention mechanism, around a mouth of an inlet pipe and the fuel tank is connected by means of vapor return piping, a part of the vapor in the fuel tank is introduced to the mouth of the inlet pipe via the vapor return piping, and it is prevented that an external air is caught up in the mouth of the inlet pipe at fuel supply from outside. Thereby generation of the vapor is restrained. There is provided the one-way valve or the check valve in a middle portion of the vapor return piping for controlling a flow of the vapor according to an internal pressure of the fuel tank.

In this type of the evaporation piping or the vapor return piping, a rubber hose is connected to each end of the one-way valve or the check valve. And, an end portion of one rubber hose is connected to, for example, a connecting pipe on a side of a roll-over valve or a differential pressure regulating valve disposed on the fuel tank. Also, an end portion of the other rubber hose is connected to a connecting pipe on a side of the canister or a connecting pipe on a side of the inlet pipe. However, as there is a tendency to restrict strictly transpiration of a fuel from a fuel supply system, a resin tube is also used instead of the rubber hose. When the resin tube is used, in many cases, the resin tube is connected to the connecting pipe by means of a connector or a quick connector. And, under the increasing demand for low fuel transpiration in recent years, minute fuel transpiration from a connecting region between the rubber hose or the resin tube and the one-way valve, etc. cannot be ignored. So, there is a need to reduce the number of connecting regions between structural elements to lower fuel transpiration.

Accordingly, it is proposed that the one-way valve or the check valve is equipped or added in a quick connector, for example, having an inserting portion for the connecting pipe. Thereby the parts count itself, i.e. the number of parts in the evaporation piping or the like, and the number of the connecting regions between the structural elements is reduced to achieve low fuel transpiration.

A known type of quick connector, in which a one-way valve or check valve is equipped or added, comprises a connector housing with a through-path that has a tube connecting portion on one axial end thereof, a pipe inserting portion on the other axial end thereof, and a valve housing between the tube connecting portion and the pipe inserting portion, in which an internal valve is housed. The tube connecting portion is provided with an annular stop rib on an outer peripheral surface (for example, refer to Patent Document 1) .

[Patent Document 1] JP-A, 2004-116733

Meanwhile, in this type of valve connector, it is not necessary to connect an internal valve with a tube directly. Thus, it becomes possible to reduce the number of the connecting regions between the structural elements, and thereby to achieve an excellent low fuel transpiration.

However, if a quick connector is provided with a valve housing between the tube connecting portion and the pipe inserting portion that has sufficient length to allow the valve to move for required axial distance, the quick connector should be designed too long in an axial direction. The quick connector with long axial length reduces a flexibility of a piping layout.

Under the circumstances described above, it is an object of the present invention to provide a valve connector that can be designed compact.

### SUMMARY OF THE INVENTION

According to the present invention, there is provided a novel valve connector. The valve connector (connector with internal valve) comprises a connector housing having a through-path or through-bore, for example, that extends in an axial direction, and an internal valve disposed in the connector housing for opening and closing the through-path. The connector housing is provided with a tube connecting portion (including a hose connecting portion) on one axial end thereof and a pipe inserting portion on the other axial end thereof. The tube connecting portion has an annular stop rib or a plurality of annular stop ribs on an outer peripheral surface thereof. The internal valve has a valve seat surface defined on or by an inner peripheral surface of the tube connecting portion, a valve body including a closing portion with an abutting surface for abutting with the valve seat surface on an outer peripheral portion of the closing portion, and a compression spring biasing the valve body in an axial direction. The valve body is housed in the tube connecting portion movably in the axial direction. Also, the valve body is configured to be movable in the axial direction within confines of the tube connecting portion that is provided with, for example, the plurality of annular stop rib. In order to secure required stop force with respect to a tube (for example, a resin tube) that is fitted on the tube connecting portion, as stated above, the tube connecting portion is provided with an annular stop rib on the outer peripheral surface thereof. Here, for example, while the annular stop rib is formed on one axial end of the tube connecting portion, the tube fitted thereon is tightened on the other axial end thereof by a resin or metal clamp. Thus, the tube connecting portion is formed with a certain axial length, or a long axial length. In the present invention, the connector is prevented to have too long axial length by providing an internal valve or a valve body within such tube connecting portion. The valve body is configured movably in the axial direction within the tube connecting portion or within confines of the tube connecting portion, for example, within an inner peripheral surface of the tube connecting portion or within confines of an inner peripheral surface of the tube connecting portion. Namely, the valve body is configured so as not to protrude out of the tube connecting portion (for example, inner peripheral surface of the tube connecting portion) in the axial direction, whether in a closed state or in an open state. Or, namely, the valve body is configured so as almost not to protrude out of the tube connecting portion (for example, inner peripheral surface of the tube connecting portion) in the axial direction, whether in a closed state or in an open state, that is, so as not to protrude out of the tube connecting portion (for example, inner peripheral surface of the tube connecting portion) in the axial direction, whether in a closed state or in an open state, or so as to slightly protrude out of the tube connecting portion (for example, inner peripheral surface of the tube connecting portion) in the axial direction in a closed state and/or in an open state. The compression spring is provided, for example, to bias the valve body in a direction toward one axial end or in one axial direction.

In the pipe inserting portion, as the case may be, a cylindrical bush is fitted for filling in between an inner peripheral surface of one axial end thereof and an inserting end portion of the pipe inserted therein, not to cause rattling in the pipe. In this case, preferably the cylindrical bush integrally has a valve cap on one axial end portion thereof for receiving the other axial end portion of the compression spring. And, it is effective to locate the valve cap at a border region between the tube connecting portion and the pipe inserting portion. In this construction, it is not necessary particularly to create an axial space for accommodating the valve cap in the connector housing. And, since installed length or installed height for the compression spring may be increased, design flexibility for the compression spring is increased, and thereby it becomes possible to secure proper operating characteristics for the internal valve.

It is effective to provide the valve body with a first guide (first guide structure) extending from the closing portion in a direction toward the other axial end, in the other axial direction or in a direction toward the pipe inserting portion, and a second guide (second guide structure) extending from the closing portion in a direction toward one axial end, in one axial direction or in a direction away from the pipe inserting portion. The first guide is formed to slide and move over the other axial end of an inner peripheral surface of the tube connecting portion with respect to the valve seat surface, while the second guide is formed to slide and move over one axial end of the inner peripheral surface of the tube connecting portion with respect to the valve seat surface. This configuration can secure stable sliding motion of the valve body. The valve body is preferably configured to be allowed to move along the tube connecting portion, for a distance preset in a range of 5% to 80% of an axial length of the tube connecting portion (for example, an inner peripheral surface of the tube connecting portion). When the valve body can move only for a distance preset to less than 5% of the axial length of the tube connecting portion, the proper operating characteristics of the internal valve cannot be secured. On the other hand, when the valve body can move for a distance preset to more than 80% of the axial length of the tube connecting portion, it is feared that the valve body operates unstably.

As described above, the valve connector according to the present invention can be constructed compact in size although an internal valve is equipped therein.

Now, the preferred embodiments will be described in detail with reference to FIGS. 1 to 9.

### BRIEF DESCRIPTION OF THE DRAWINGS

FIG. 1 is a sectional view of a first valve connector according to the present invention.

FIG. 2 is a partly broken perspective view of the first valve connector.

FIG. 3 is a perspective view of a retainer.

FIG. 4 is an enlarged sectional view of a region of an internal check valve.

FIG. 5 is a perspective view of a valve body.

FIG. 6 is a sectional view showing that a pipe is connected to the valve connector.

FIG. 7 is a view for explaining that the valve connector is used for evaporation piping.

FIG. 8 is a view showing a state that the valve body is open.

FIG. 9 is a sectional view of a second valve connector according to the present invention.

### DETAILED DESCRIPTION OF THE PREFERRED EMBODIMENTS

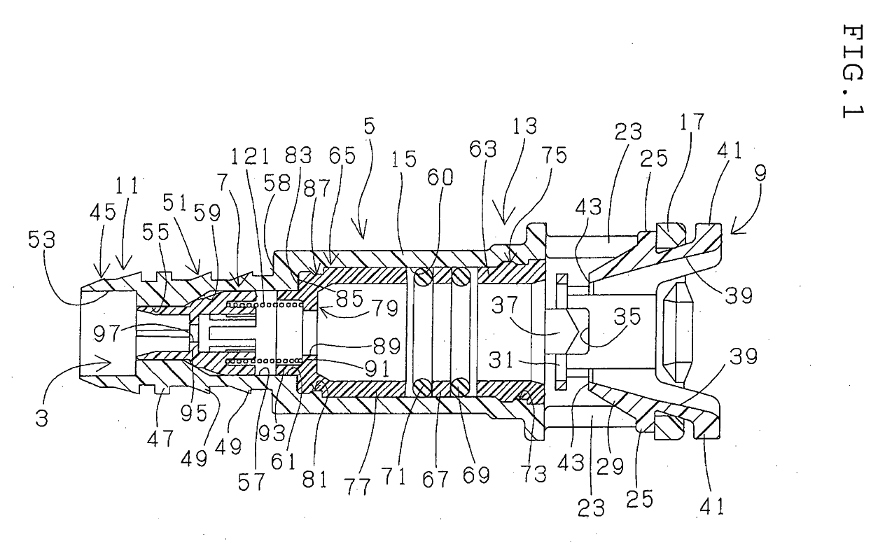

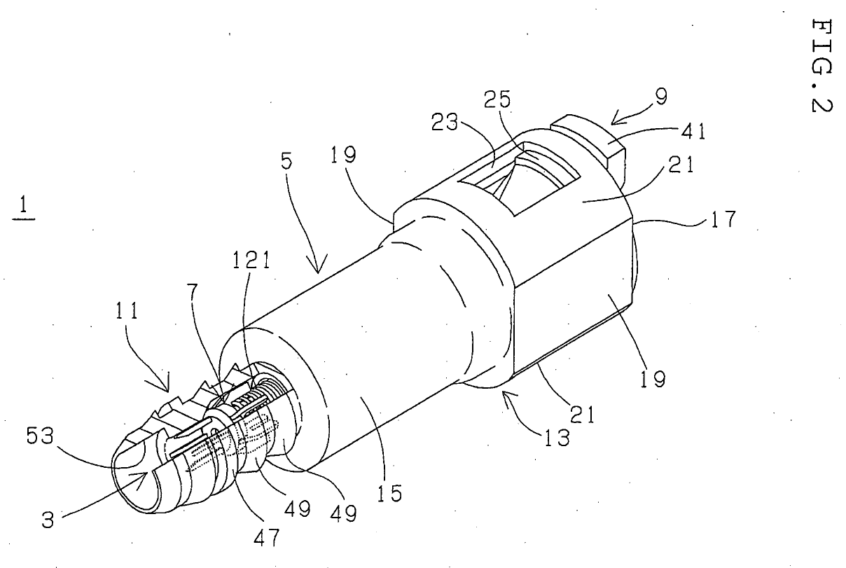

A first valve connector 1 according to the present invention, as shown in FIGS. 1 and 2, is used, for example, for evaporation piping or vapor return piping of a tank of fuel such as gasoline, etc., to control flow of a vapor. The first valve connector 1 comprises a connector housing 5 having a through-path or through bore 3 in an axial direction, an internal check valve 7 fitted and incorporated in the connector housing 5, and a retainer 9 fitted to the connector housing 5. The connector housing 5 is made of glass fiber reinforced polyamide (PA/GF), for example, glass fiber reinforced nylon 6. The retainer is made of polyamide (PA), for example, nylon 12. The connector housing 5 integrally has a tube connecting portion 11 of a small diameter on one axial end thereof, and a pipe inserting portion 13 on the other axial end thereof. The pipe inserting portion 13 integrally includes a pipe support portion 15 on one axial end thereof, and a retainer holding portion 17 on the other axial end thereof for housing and holding the retainer 9.

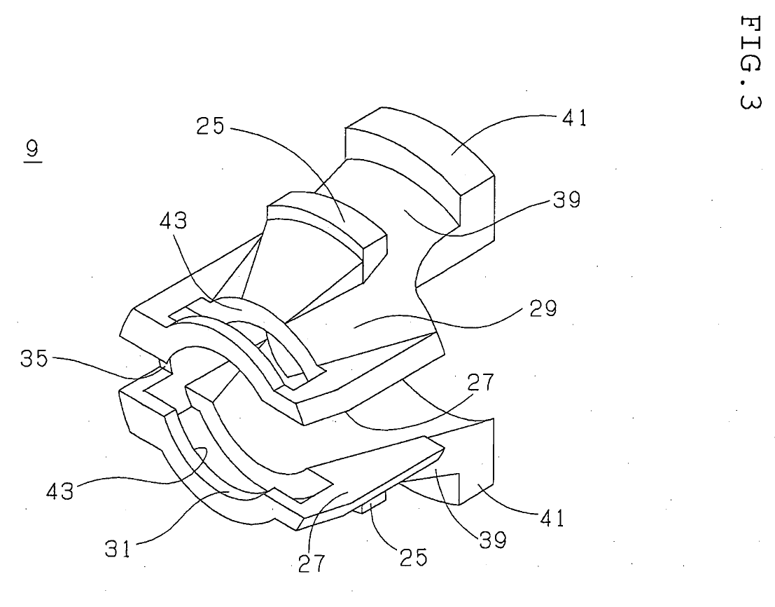

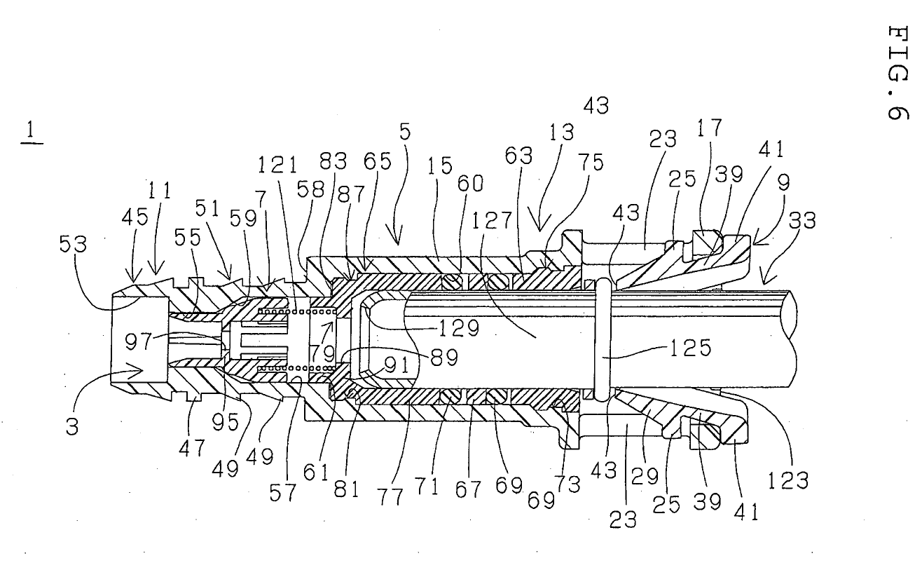

The retainer holding portion 17 of the connector housing 5 has a peripheral wall that defines planar portions (portions with flat outer surfaces) 19, 19 at diametrically symmetrical positions and arcuate portions 21, 21 that are formed with engaging windows 23, 23 in diametrically opposed relation to each other. The retainer 9 that is received in the retainer holding portion 17 is relatively flexible, and is formed so as to be resiliently deformable. The retainer 9 has a main body 29 of C-shape in cross-section, wherein a relatively large space for deformation is defined between circumferential opposite end portions 27, 27 thereof, as shown in FIG. 3. The main body 29 is provided with a pair of engaging tabs 25, 25 projecting radially outward at diametrically symmetrical positions of the other axial end portion thereof. An inner surface of the main body 29, except for the circumferential opposite end portions 27, 27 and a region diametrically opposed to the space for deformation, is tapered toward one axial direction so as to diametrically contract gradually. And, except for the circumferential opposite end portions 27, 27 and the region diametrically opposed to the space for deformation, one axial end portion 31 of the main body 29 is formed with an inner diameter almost equal to an outer diameter of a pipe 33 (refer to FIG. 6). The region of the main body 29 diametrically opposed to the space for deformation has an inner surface like a part of a cylindrical inner surface. The one axial end portion 31 of the region of the main body 29 diametrically opposed to the space for deformation is formed with a cut-out indent 35. A rotation preventive projection 37 that is formed on one axial end portion of an inner peripheral surface of the retainer holding portion 17 seats in the cut-out indent 35 to restrain rotational movement of the retainer 9 in the retainer holding portion 17.

On the other axial end portion of the main body 29 of the retainer 9, a pair of operating arms 39, 39 are formed integrally at positions corresponding to the engaging tabs 25, 25 so as to extend at angle toward radially outward in the other axial direction, respectively. Each of the operating arms 39, 39 has a latching end 41 projecting radially outward on the other axial end portion thereof. The one axial end portion 31 of the main body 29 is formed with engaging slits 43, 43 extending in a circumferential direction in opposed relation with each other. Thus configured retainer 9 is inserted and fitted in the retainer holding portion 17 such that the engaging tabs 25, 25 seat in the engaging windows 23, 23 of the retainer holding portion 17 and the latching ends 41, 41 engage with the other axial end thereof.

The tube connecting portion 11 of the connector housing 5 comprises one axial end portion 45 of generally right triangle cross-sectional shape having an outer peripheral surface diametrically expanding gently toward the other axial direction, and the other axial end portion 51 having an outer peripheral surface extending like a generally simple cylindrical outer shape or surface on the other axial end with respect to the one axial end portion 45. The other axial end portion 51 is provided on the outer peripheral surface thereof with an annular projecting stop portion 47 of rectangular cross-sectional shape and two annular projecting stop portions 49, 49 of right triangle cross-sectional shape diametrically expanding toward the other axial end. The annular projecting stop portions 47, 49, 49 are arranged in axially spaced relation sequentially from one axial end to the other axial end of the other axial end portion 51. The through-path (inner peripheral surface) 3 of the tube connecting portion 11 includes a large diameter one-end bore 53 of the one axial end portion 45, a small diameter support bore 55 on one axial end of the other axial end portion 51, a large diameter valve bore 57 on the other axial end of the other axial end portion 51, and a valve seat bore 59 of the other axial end portion 51 between the support bore 55 and the valve bore 57. The valve seat bore 59 as a valve seat surface diametrically expands from the other end of the support bore 55 to one end of the valve bore 57 in a reverse tapered manner. The one-end bore 53 is open at one axial end or one axial extreme end of the tube connecting portion 11, and the valve bore 57 has an inner diameter equal to or generally equal to that of the one-end bore 53. Usually, a tube is fitted on the tube connecting portion 11 for an entire length thereof. An outer peripheral surface of the tube connecting portion 11 extends in the other axial direction (namely, in a direction away from the one-end bore 53), to a radial surface 58 of a stepped portion of the connector housing 5.

The through-path (inner peripheral surface) 3 of the pipe support portion 15 of the connector housing 5 includes a main-body bore 60 extending like a generally simple cylindrical inner surface of large diameter, and a small-diameter bore 61 provided continuously from the main body bore 60 on one axial end with respect to the main-body bore 60. The small diameter bore 61 has an inner diameter equal to or generally equal to that of the valve bore 57, and is provided continuously to the valve bore 57.

In the through-bore 3 of the pipe support portion 15, an annular bush 63 made of PA/GF, for example, glass fiber reinforced nylon 12 is fitted on the other axial end thereof, and a tubular or cylindrical bush 65 made of polyacetal (POM) or glass fiber reinforced nylon 12 is fitted on the one axial end thereof. Further, between the annular bush 63 and the cylindrical bush 65 in the through-bore 3, a first O-ring 69 and a second O-ring 71 are fitted with an intervening collar 67 made of POM or glass fiber reinforced nylon 12 therebetween. Fixing projection and receptacle portion 73 are formed in the other axial end portion of an inner peripheral surface of the main-body bore 60 of the pipe support portion 15, while engaging projection and receptacle portion 75 are formed on an outer peripheral surface of the annular bush 63. The annular bush 63 is mounted to the pipe support portion 15 so as not to be allowed to move in the axial direction due to fit-in relation of the engaging projection and receptacle portion 75 and the fixing projection and receptacle portion 73. The cylindrical bush 65 has a generally simple cylindrical bush body 77 and a valve cap 79 that is integrally connected to and formed on one axial end portion of the bush body 77. The valve cap 79 comprises a part of the internal check valve 7. The bush body 77 is fitted in the main-body bore 60 of the pipe support portion 15, and the valve cap 79 is located with one axial end portion thereof protruding in the small-diameter bore 61. The annular bush 63 and the bush body 77 of the cylindrical bush 65 have generally identical inner diameter. For material of the first O-ring 69 on the other axial end, used is fluorosilicone rubber (FVMQ) that is excellent in waterproof and dust proof properties, and has excellent low-temperature resistance and ozone resistance. And, for material of the second O-ring 71 on the one axial end, used is fluoro rubber that is excellent in waterproof and dust proof properties, and has excellent fuel-resistance such as resistance to gasoline and ozone resistance.

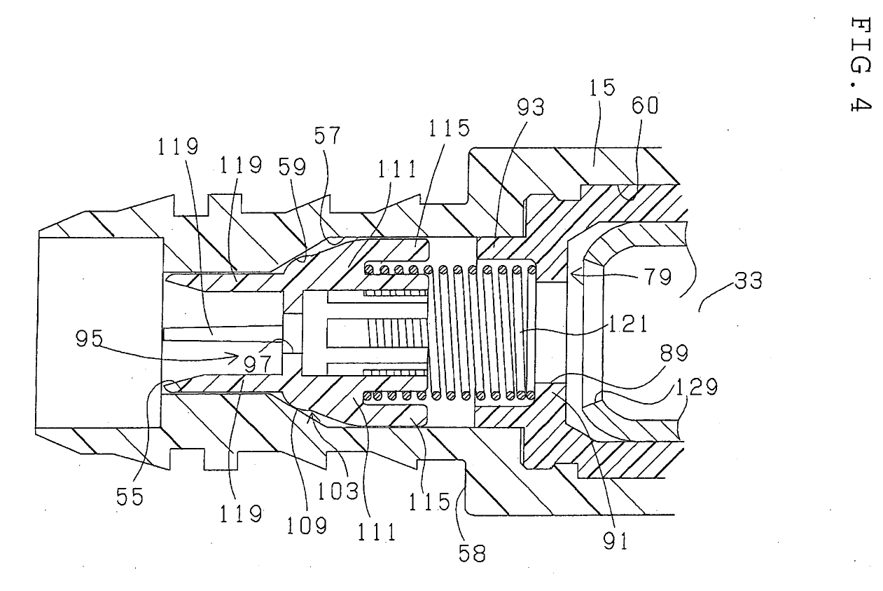

A fixing projection and receptacle portion 81 is formed in one axial end portion of the inner peripheral surface of the main-body bore 60 of the pipe support portion 15, while an engaging projection and receptacle portion 87 is formed on an outer peripheral surface of one axial end portion of the bush body 77 of the cylindrical bush 65. The cylindrical bush 65 is mounted to the pipe inserting portion 13 or the pipe support portion 15 so as not to be allowed to move in the axial direction due to contact relation of an annular outer end surface 83 on one axial end of the bush body 77 and an annular inner end surface 85 on one axial end of the main-body bore 60, and fit-in relation of the engaging projection and receptacle portion 87 and the fixing projection and receptacle portion 81. As best seen in FIG. 4, the valve cap 79 has an annular spring bearing portion 91 formed integrally on the one axial end portion of the bush body 77 and expanding radially inward from the one axial end portion of the bush body 77, and a cylindrical portion 93 extending slightly in the one axial direction integrally from an outer periphery of the spring bearing portion 91. An inner periphery of the annular spring bearing portion 91 defines a communication bore 89, and the cylindrical portion 93 is fitted in the small-diameter bore 61.

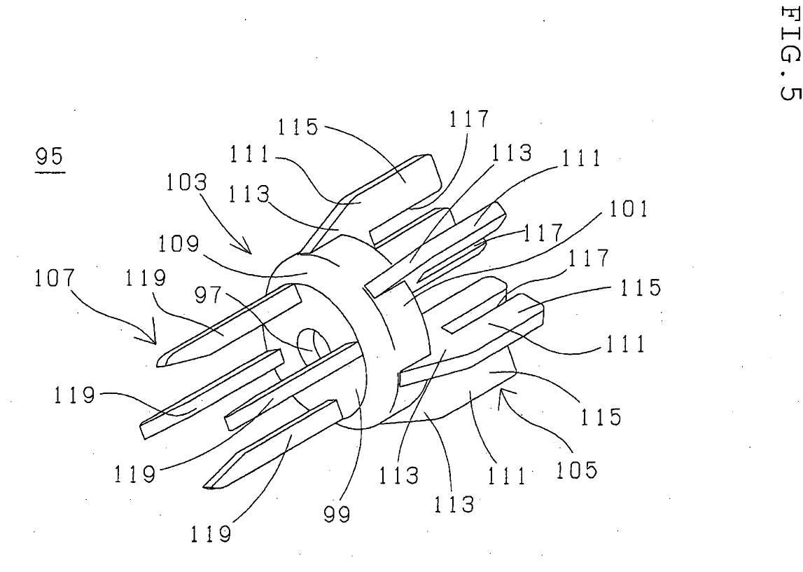

In the tube connecting portion 11, the valve body 95 that comprises a part of the internal check valve 7 is housed. With reference to FIG. 5, the valve body 95 integrally has a closing portion 103, a guide structure on a valve bore side or first guide structure (first guide) 105 and a guide structure on a support bore side or second guide structure (second guide) 107. The closing portion 103 integrally includes a thin-walled disk portion 99 that has a small through-bore 97 at the center thereof, and an annular portion 101 extending short in the direction away from the support bore 55, i.e., in the other axial direction on an outer periphery of the disk portion 99. The first guide structure 105 is formed on the annular portion 101 of the closing portion 103 so as to extend in the other axial direction, and the second guide structure 107 extends in the one axial direction from the outer periphery of the disk portion 99 of the closing portion 103. For material of the valve body 95, POM is used. In the closing portion 103, an outer peripheral surface (connecting outer peripheral surface) 109 of a connecting region of the disk portion 99 and the annular portion 101 is formed so as to have an arcuate cross-section raised outward, and defines an abutment surface abutting with an inner peripheral surface (valve seat surface) of the valve seat bore 59 that is formed in straight-line cross-section (also refer to FIG. 5). Meanwhile, when an internal valve is configured to function as simple check valve, the small through-bore 97 is not provided.

As well shown in FIG. 5, the first guide structure 105 has six first slide legs 111 shaped like plate or sheet that are integrally arranged equally spaced (specifically, spaced at 60°) in a circumferential direction on the annular portion 101. Each of the first slide legs 111 has a support portion 113 formed on the annular portion 101, and a rectangular slide portion or first slide portion 115 integrally formed continuously on the other axial end of the support portion 113. The guide or the first slide leg 111 is arranged such that a plate thickness direction of the first slide leg 111 corresponds to a tangential direction with respect to the annular portion 101. A radial distance from a center of the annular portion 101 to a radially outer surface or radially outer end surface of each first slide portion 115 is designed generally equal to a radius of the inner peripheral surface of the valve bore 57, or slightly smaller than the radius of the inner peripheral surface of the valve bore 57. The radially outer surface or radially outer end surface of the first slide portion 115 is formed in a surface extending in the axial direction so as to slide over the inner peripheral surface of the valve bore 57. In each of the first slide portions 115, defined is a support recess 117 extending from the other axial end thereof in the one axial direction. The support recess 117 is located at a radial position generally identical to the annular portion 101.

The second guide structure 107 has four second slide legs 119 like plate that are integrally arranged equally spaced (specifically, spaced at 90°) in a circumferential direction on the outer periphery of the disk portion 99. Each of the second slide legs 119 is arranged such that a plate thickness direction of the second slide legs 119 corresponds to a tangential direction with respect to the disk portion 99. The second slide leg 119 is formed so as to include a radially outer end, radially outer surface or radially outer end surface extending in the axial direction. A radial distance from a center of the disk portion 99 to the radially outer end or radially outer end surface of each second slide portion 119 is designed equal to or generally equal to a radius of the inner peripheral surface of the support bore 55 of the tube connecting portion 11, or slightly smaller than the radius of the inner peripheral surface of the support bore 55. The radially outer end surface of the second slide leg 119 is formed so as to slide over the inner peripheral surface of the support bore 55 of the tube connecting portion 11.

Thus configured valve body 95 is biased in the one axial direction by a compression coil spring 121 such that the second guide 107 enters in the support bore 55 of the tube connecting portion 11 and the outer peripheral surface 109 of the closing portion 103 abuts one axial end position or one axial end portion of the inner peripheral surface of the valve seat bore 59. One axial end portion of the compression coil spring 121 is received in the support recesses 117 formed in the first slide portions 115 of the first slide legs 111, and the other axial end thereof abuts the spring bearing portion 91 of the valve cap 79. The cylindrical portion 93 of the valve cap 79 functions to hold the other axial end portion of the compression coil spring 121 while receiving it therein.

As well shown in FIG. 6, a mating pipe, i.e. the pipe 33, for example, made of metal or resin is inserted into an opening or insertion opening 123 on an end of the retainer holding portion 17, more specifically, in the main body 29 of the retainer 9 from a side of the latching ends 41, 41 of the operating arms 39, 39, and is fitted in the first valve connector 1. The pipe 33 has an inserting end portion 127 on one axial end thereof where an annular engaging projection 125 is formed on an outer peripheral surface. The pipe 33 is pushed, and fittingly inserted into the first valve connector 1 or the connector housing 5 so that the annular engaging projection 125 advances radially expanding the main body 29 of the retainer 9 until the annular engaging projection 125 seats in the engaging slits 43, 43 in snap-engagement relation therewith. When the pipe 33 is correctly inserted in the connector housing 5, one axial end of the pipe 33 is located short of the valve cap 79 (on the other axial end with respect to the valve cap 79). The annular engaging projection 125 that seats and snap-engages in the engaging slits 43, 43 of the main body 29 of the retainer 9 blocks or limits further axial in-and-out movement of the pipe 33 with respect to the first valve connector 1. That is, the pipe 33 is almost locked against relative axial movement in the first valve connector 1 by the annular engaging projection 125 that seats and snap-engages in the engaging slits 43, 43. The inserting end portion 127 of the pipe 33 is inserted in the annular bush 63 and the cylindrical bush 65 without rattling, and a seal is formed between the pipe 33 and the first valve connector 1 by the first and the second O-rings 69, 71. By the way, a communication bore 89 of the valve cap 79 is formed to have a diameter generally equal to a flow-in opening 129 of the pipe 33 or a diameter slightly smaller than the flow-in opening 129.

In the event of removing the pipe 33 from the first valve connector 1, for example, the latching ends 41, 41 of the operating arms 39, 39 are pressed radially inwardly from outside to narrow a radial distance between the operating arms 39, 39, thus a radial distance between the engaging tabs 25, 25. Thereby the engaging tabs 25, 25 are out of the engagement windows 23, 23, and the retainer 9 can be relatively pulled out of the connector housing 5. As the retainer 9 is relatively pulled out of the connector housing 5, the pipe 33 is also pulled out of the first valve connector 1 or the connector housing 5 along with the retainer 9.

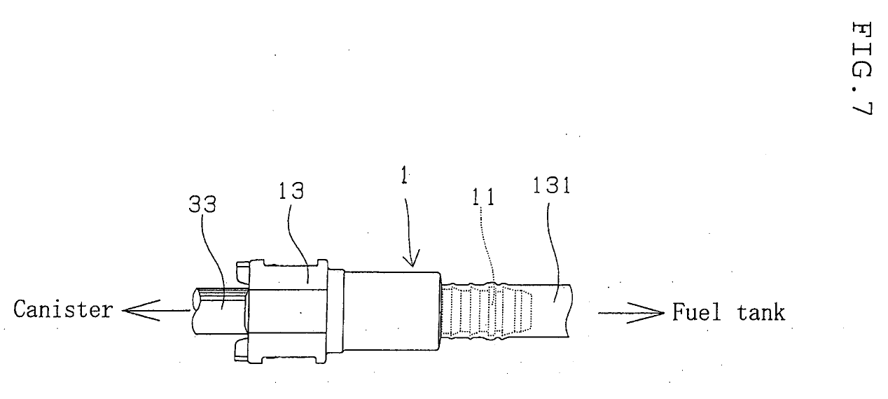

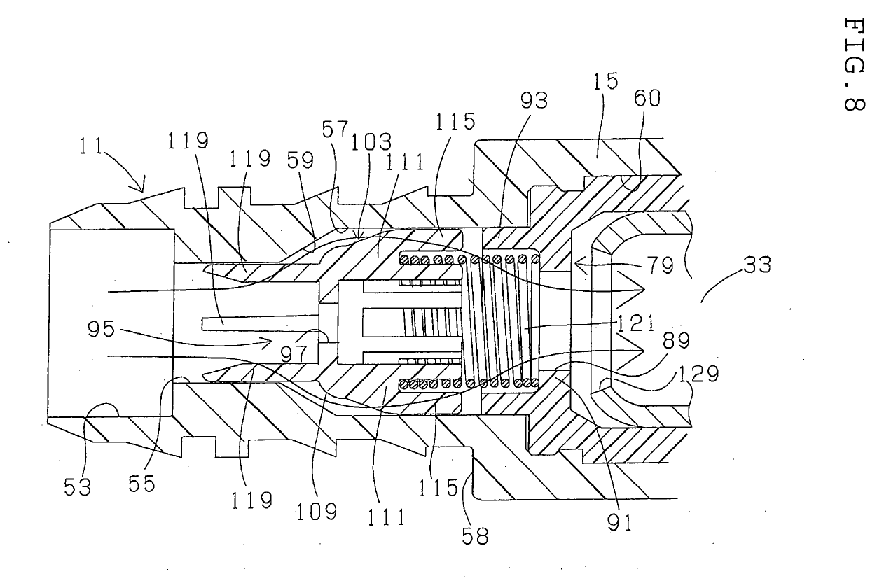

The first valve connector 1 may be used for evaporation piping as shown in FIG. 7. Here, a resin tube 131 that is connected to a fuel tank is fitted on an outer periphery of the tube connecting portion 11 of the first valve connector 1, the pipe 33 of a canister or a canister side is relatively inserted in the pipe inserting portion 13, and thereby the evaporation piping is constructed. In this construction, when a vapor pressure in the fuel tank increases, a valve body 95 moves or travels in the other axial direction against a spring force of the compression coil spring 121, as shown in FIG. 8. When the valve body 95 travels in the other axial direction and the outer peripheral surface 109 of the closing portion 103 moves away from one axial end position or one axial end portion of an inner peripheral surface of the valve seat bore 59, a vapor passes through a large diameter annular gap between the connecting outer peripheral surface 109 of the closing portion 103 and the inner peripheral surface of the valve seat bore 59, and flows in the valve bore 57. And, then the vapor that flows in the valve bore 57 further flows in the main body bore 60 of the pipe support portion 15 through the communication bore 89 (refer to FIG. 8). Further, the vapor flows in the pipe 33 via the flow-in opening 129, and is sent to the canister. The valve body 95 can travel in the other axial direction until the first slide portions 115 of the first slide legs 111 (more specifically, the other axial end of the first slide portions 115) abut the cylindrical portion 93 (one axial end of the cylindrical portion 93) of the valve cap 79. Namely, the valve body 95 is allowed to move or travel in the other axial direction until the other axial end thereof is located at an axial position identical to or generally identical to the other axial end of the tube connecting portion 11 or the valve bore 57. Here, moving distance of the valve body 95 (traveling distance of the valve body 95 in the axial direction from a closed state to an open state) is about 11% of an axial length of the tube connecting portion 11, for example, an axial length of an inner peripheral surface of the tube connecting portion 11, namely, total axial length of the one-end bore 53, the support bore 55, the valve seat bore 59 and the valve bore 57. Axial movement of the valve body 95 is accompanied by sliding motion of the first sliding legs 111 over the inner peripheral surface of the valve bore 57, and sliding motion of the second sliding legs 119 over the inner peripheral surface of the support bore 55. Therefore, it is not feared that the valve body 95 tilts during traveling of valve body 95. And, as each of the second slide legs 119 is designed longer than an axial distance between the first slide leg 111 and the cylindrical portion 93 of the valve cap 79 when the valve body 95 is in a closed state, or longer than traveling distance of the valve body 95 in the axial direction, the second slide leg 119 does not slip out of the support bore 55 due to traveling of the valve body 95. Meanwhile, an axial position of the other axial end or the other axial extreme end of the valve bore 57 of the tube connecting portion 11 conforms to an axial position of one axial end or the one axial extreme end of the cylindrical portion 93 of the valve cap 79.

In the first valve connector 1 of such configuration, the valve body 95 does not start moving or traveling in the other axial direction until the vapor pressure in the fuel tank reaches a predetermined value, namely a value of a minimum activation pressure of the valve body 95. So, if the valve body 95 is provided with a completely closed construction, the vapor cannot be sent toward the canister when a pressure in the fuel tank is low. However, even if the vapor pressure in the fuel tank is low, as the case may be, it is suitable to control the pressure in the fuel tank property by allowing the vapor to flow to the canister. Thus, the small through-bore 97 is formed in the disk portion 99 of the valve body 95 so as to allow the vapor to flow even when the pressure in the fuel tank is low. The small through-bore 97 is formed with a diameter about one-third to one-fifth the diameter of the support bore 55 of the tube connecting portion 11 or an abutting region of the outer peripheral surface 109 against the inner peripheral surface of the valve seat bore 59.

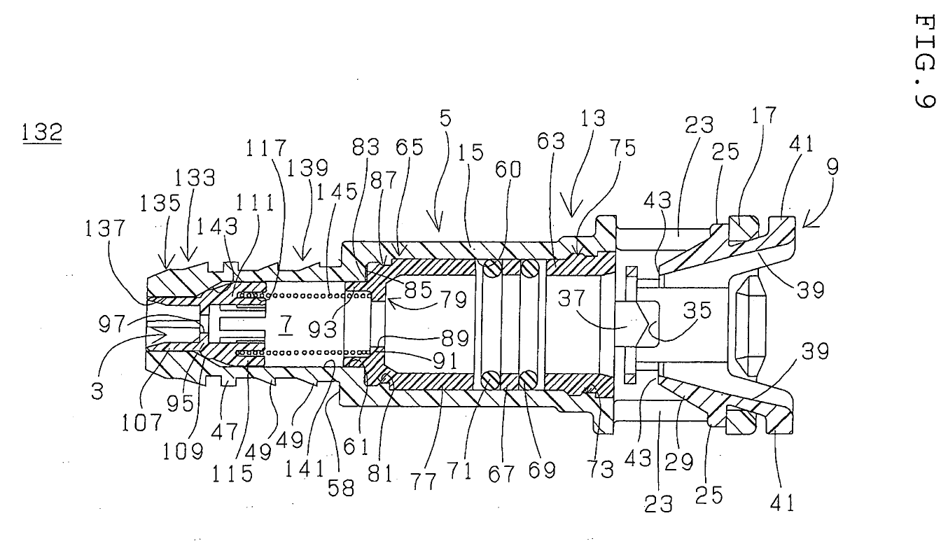

FIG. 9 shows a second valve connector 132 according to the present invention, which is also used for evaporation piping or vapor return piping of a tank of a fuel such as gasoline, etc., to control flow of a vapor. The second valve connector 132 is constructed by modifying configuration of the through-path 3 of the tube connecting portion 11 and the internal check valve 7 of the first valve connector 1. Since the second valve connector 132 is otherwise the same as the first valve connector 1, generally, identical elements are indicated with identical reference numerals, and a redundant explanation will be omitted.

The through-path or through-bore (an inner peripheral surface thereof) 3 of a tube connecting portion 133 (having the same construction as the tube connecting portion 11 except for a shape of the through-path 3) includes a small diameter support bore 137 of one axial end portion 135, a large diameter valve bore 141 of the other axial end portion 139, and a valve seat bore 143 extending from the other axial end portion of the one axial end portion 135 toward one axial end portion of the other axial end portion 139. The valve seat bore 143 as a valve seat surface is configured to diametrically expand from the other axial end of the support bore 137 to one axial end of the valve bore 141 in a reverse tapered manner. The support bore 137 is open at one axial end or one axial extreme end of the tube connecting portion 133. The small diameter bore 61 of the pipe support portion 15 has an inner diameter identical to or generally identical to that of the valve bore 141. Usually, a tube is fitted to or on the tube connecting portion 133 for an entire length thereof. An outer peripheral surface of the tube connecting portion 133 extends in the other axial direction to a radial surface 58 of a stepped portion of the connector housing 5.

In the tube connecting portion 133, a valve body 95 that comprises a part of the internal check valve 7 is housed. The valve body 95 is biased in the one axial direction by a compression coil spring 145 such that the second guide structure 107 enters in the support bore 137 of the tube connecting portion 133 and the outer peripheral surface 109 of the closing portion 103 abuts one axial end position or one axial end portion of an inner peripheral surface (valve seat surface) of the valve seat bore 143 (also refer to FIG. 5). One axial end portion of the compression coil spring 145 is received in the support recesses 117 formed in the first slide portions 115 of the first slide legs 111, and the other axial end thereof abuts the spring bearing portion 91 of the valve cap 79. The compression coil spring 145 has a length equal to or more than twice the length of the compression coil spring 121. Here, the valve body 95 is configured such that the one axial end or one axial extreme end of the second guide or second guide structure 107 conforms to the one axial end or one axial extreme end of the tube connecting portion 133 or one axial end or one axial extreme end of the support bore 137 in an axial position, in the closed state.

In this construction, when a vapor pressure in the fuel tank increases, the valve body 95 moves or travels in the other axial direction against a spring force of the compression coil spring 145. When the valve body 95 travels in the other axial direction and the outer peripheral surface 109 of the closing portion 103 moves away from one axial end portion or one axial end position of the inner peripheral surface of the valve seat bore 143, a vapor passes through a large diameter annular gap or clearance between the connecting outer peripheral surface 109 of the closing portion 103 and the inner peripheral surface of the valve seat bore 143, and flows in the valve bore 141. Then, the vapor that flows therein, further flows in the main body bore 60 of the pipe support portion 15 through the communication bore 89 of the valve cap 79, flows in the pipe 33 via the flow-in opening 129 and is sent to a canister (refer to FIG. 8). The valve body 95 can travel long distance in the other axial direction until the first slide portions 115 (more specifically, the other axial ends or the other axial extreme ends of the first slide portions 115) of the first slide legs 111 abut the cylindrical portion 93 (more specifically, one axial end or one axial extreme end of the cylindrical portion 93) of the valve cap 79. Here, traveling distance of the valve body 95 (traveling distance in the axial direction for the valve body 95 to turn from a closed state to an open state) is about 40% of an axial length of the tube connecting portion 133, for example, an axial length of an inner peripheral surface of the tube connecting portion 133, namely, a total axial length of the support bore 137, the valve seat bore 143 and the valve bore 141. Since axial movement of the valve body 95 is accompanied by sliding motion of the first sliding legs 111 over the inner peripheral surface of the valve bore 141 and sliding motion of the second sliding legs 119 over the inner peripheral surface of the support bore 137, it is not feared that the valve body 95 tilts during traveling of the valve body 95. Meanwhile, the other axial end or the other axial extreme end of the valve bore 141 of the tube connecting portion 133 conforms to one axial end or one axial extreme end of the cylindrical portion 93 of the valve cap 79 in an axial position.

The valve connector according to the present invention may be adapted, for example, for piping for vapor in a motor vehicle, and allows to deal with an environmental problem as well as to secure layout flexibility in piping for vapor.

What is claimed is:

1. A valve connector, comprising:
a connector housing having a through-path, the connector housing being provided with a tube connecting portion on one axial end thereof and a pipe inserting portion on the other axial end thereof, the tube connecting portion having an annular stop rib on an outer peripheral surface thereof,
an internal valve disposed in the connector housing for opening and closing the through-path, the internal valve having a valve seat surface defined on an inner peripheral surface of the tube connecting portion, a valve body including a closing portion with an abutting surface for abutting with the valve seat surface on an outer peripheral portion of the closing portion, and a compression spring biasing the valve body in an axial direction, the valve body being housed in the tube connecting portion movably in the axial direction, and
the valve body being configured to be movable in the axial direction within confines of the tube connecting portion that is provided with the annular stop rib.

2. The valve connector as set forth in claim 1, wherein the compression spring biases the valve body in a direction toward one axial end.

3. The valve connector as set forth in claim 2, wherein a cylindrical bush is fitted in the pipe inserting portion for filling in between an inner peripheral surface of one axial end of the pipe inserting portion and an inserting end portion of the pipe that is inserted therein, the cylindrical bush integrally has a valve cap on one axial end portion thereof for receiving the other axial end portion of the compression spring, and the valve cap is located at a border region between the tube connecting portion and the pipe inserting portion.

4. The valve connector as set forth in claim 1, wherein the valve body further includes a first guide extending from the closing portion in a direction toward the other axial end and a second guide extending from the closing portion in the direction toward one axial end, the first guide is formed so as to slide over the other axial end of an inner peripheral surface of the tube connecting portion with respect to the valve seat surface, and the second guide is formed so as to slide over one axial end of the inner peripheral surface of the tube connecting portion with respect to the valve seat surface.

5. The valve connector as set forth in clam 1, wherein the valve body is allowed to move along the tube connecting portion, for a distance preset in a range of 5% to 80% of an axial length of the tube connecting portion.
